(19) United States
(12) Patent Application Publication
(10) Pub. No.: US 2005/0004966 A1
(43) Pub. Date: Jan. 6, 2005

(54) System and method for efficient VLSI architecture of finite fields

(76) Inventor: Kuo-Yen Fan, Nantou City (TW)

Correspondence Address: Lawrence D. Eisen;c/o Shaw Pittman LLP, 1650 Tysons Blvd., McLean, VA, 22102, US

(21) Appl. No.: 10/883,669

(22) Filed: Jul. 6, 2004

Related U.S. Application Data
(60) Provisional application No. 60/484,312, filed on Jul. 3, 2003.

(51) Int. Cl. G06F 7/00

(52) U.S. Cl. 708/492

(57) ABSTRACT

An architecture according to the present invention performs arithmetic operations on a composite field over dual basis. The ground field arithmetic is performed under dual basis. Therefore, the proposed architectures has the advantages of both composite field and dual basis processing, area efficiency and timing efficiency. Moreover, if the ground field GF(2ⁿ) arithmetic is implemented by bit-serial operation, the overall throughput of the composite field GF((2ⁿ)^{k}) arithmetic will be twice than the one implemented in the finite field GF(2^{m})m=nk).

This application claims the benefit of U.S. Provisional Application No. 60/484,312, filed Jul. 3, 2003, which is herein incorporated by reference in its entirety.

### BACKGROUND

1. Field of the Invention

The present invention relates generally to an architecture for a finite fields arithmetic operator. More particularly, the present invention relates to an architecture for finite fields multipliers and dividers (exponentiators) that are suitable for VLSI implementation.

2. Background of the Invention

Finite fields arithmetic has wide spread applications in digital communication systems, including cryptography and channel coding. For example, finite fields arithmetic may be used in error correction applications, such as DVD, CD-ROM, gigabit Ethernet, ADSL/VDSL, cable modem, and processing errors for channel equalization. Alternatively, finite fields may be used in security applications, such as an elliptical curve cryptography.

FIG. 1 is a schematic diagram of a conventional finite field GF(2^{m}). Finite field 130, GF(2^{m}), contains 2^{m} elements. GF(2^{m}) is an extension field of prime field 110, GF(2), which has elements 0 and 1. All finite fields contain a zero element, a unit element, a primitive element a and at least one primitive irreducible polynomial 120, p(x)=x^{m}+pₘ₋₁x^{m-1}+pₘ₋₂x^{m-2}+. . . +p₁x+p₀, over GF(2) associated with it. As used throughout this application, the following operations, “+” and “.”, denote logic XOR and AND operations, respectively.

The primitive element a generates all nonzero elements of GF(2^{m}) and is a root of the primitive polynomial p(x), such that GF(2^{m})=>p(α)=0. The nonzero elements of GF(2^{m}) can be represented in two forms, exponential form and polynomial form. In exponential form (e.g., power representation), they are represented as power of the primitive element α, i.e., GF(2^{m})={0, α¹, α², . . . , α²^{^{m}}⁻²}.

The primitive polynomial p(x) may be written as p(x)=x^{m}+P(x), where P(x)=pₘ₋₁x^{m-1}+pₘ₋₂x^{m-2}+. . . +p₁x+p₀. Because α is a root of the primitive polynomial p(x),
α^{m}=pₘ₋₁α^{m-1}+pₘ₋₂x^{m-2}+. . . +p₁α+p₀,
which is equivalent to α^{m}=P(α). Therefore, the elements of GF(2^{m}) can also be expressed as polynomials of a with a degree less than m by performing mod p(a) operation to α^{k}, 0≦k≦2^{m}−2. This form is referred to hereafter as polynomial form: GF(2^{m})={A|A=aₘ₋₁x^{m-1}+aₘ₋₂x^{m-2}+. . . +a₁x+a₀, aᵢ∈GF(2), 0≦i≦m−1}.

Table 1 illustrates an exemplary construction of GF(2^{m}), for m=3 in exponential representation and polynomial representation. Here, GF(2³) has a primitive in G(2) with a root, α, defined such that α³+α+1=0=>α³=α+1. Also, as described above, the standard basis or polynomial basis is {1, α, α², . . . , α^{m-1}}. Constructing the Galois Field GF(2³) in exponential and polynomial representations, yields the following table:

TABLE 1
Exponential and Polynomial Representation

| Exponential Representation | Polynomial Representation | Vector |
|---|---|---|
| 0 | 0 | 000 |
| α⁰ | 1 | 001 |
| α¹ | α | 010 |
| α² | α² | 100 |
| α³ | α + 1 | 011 |
| α⁴ | α² + α | 110 |
| α⁵ | α³ + α² = α² + α + 1 | 111 |
| α⁶ | α² + 1 | 101 |
| α⁷ | 1 | 001 |

The arithmetic operation of addition in finite fields is a relatively straightforward operation. Generally, polynomial representation is generally used for finite field arithmetic operation, and addition is carried out using bit-independent XOR operations. Using Table 1, an exemplary arithmetic addition operation in finite fields is illustrated as follows: α²+α¹=(α²)+(α²+α+1)=α+1=α³. Note also that in vector form adding coordinate to coordinate: α+1=(100)+(111)=(011) or α³.

However, the arithmetic operations of multiplication, inversion, division and exponentiation are more complicated (and inefficient) functions. Multiplication, for example, is carried out using polynomial multiplication and modulo operations. Power representation is efficient for finite fields multiplication, division and exponentiation, where these operations can be carried out by adding, subtracting or multiplying exponents modulo 2^{m}−1.

For example, referring to Table 1 for the construction of GF(2³), consider the following multiplication of the polynomials α⁴ and α⁵: α⁴·α⁵=(α^{9mod(2\hat{ }(3)-1)})=α². Division is performed the same as addition: a/b=α^{(i-j)mod(2\hat{ }(m)-1)}.

More particularly, division and exponentiation is calculated using two-way log and anti-log conversion tables, or conversion circuitry to convert operands from polynomial representation to power representation, modulo add, subtract or multiply the exponents of operands, and then convert the result from power representation to polynomial representation.

Thus, for the operation of multiplication or division, an adder, a mod operator and a lookup ROM table to store a logarithm is required. The size of the ROM table is approximately 2^{m}. When m is large, the size of the ROM table will affect the circuit area.

FIG. 2 is a schematic diagram of a conventional bit-serial standard basis multiplier architecture. The architecture illustrates the multiplication of elements A and B, which are both in standard basis form. Thus,

$$\begin{matrix}\begin{matrix}A = {a}_{m - 1} {α}^{m - 1} + {a}_{m - 2} {α}^{m - 2} + … + {a}_{1} α + {a}_{0} \\ B = {b}_{m - 1} {α}^{m - 1} + {b}_{m - 2} {α}^{m - 2} + … + {b}_{1} α + {b}_{0} \\ C = A \cdot B {=}^{Δ} AB mod p ( α ) \\ = {b}_{0} A + {b}_{1} ( A αmod p ( α ) ) + {b}_{2} ( A {α}^{2} mod p ( α ) ) + … + \\ {b}_{m - 1} ( A {α}^{m - 1} mod p ( α ) ) {α}^{m} + {p}_{m - 1} {α}^{m - 1} + … + \\ {p}_{1} α + {p}_{0} \\ \frac{{a}_{m - 1}}{\sqrt{{a}_{m - 1} {α}^{m} + {a}_{m - 2} {α}^{m - 1} + … + {a}_{1} {α}^{2} + {a}_{0} α… A α}}\end{matrix} \\ \frac{{a}_{m - 1} {α}^{m} + {a}_{m - 1} {p}_{m - 1} {α}^{m - 1} + … + {a}_{m - 1} {p}_{1} α + {a}_{m - 1} {p}_{0}}{( {a}_{m - 2} + {a}_{m - 1} {p}_{m - 1} ) {α}^{m - 1} + … + ( {a}_{0} + {a}_{m - 1} {p}_{1} ) α + {a}_{m - 1} {p}_{0}}\end{matrix}$$

Thus, the standard basis multiplication in finite fields requires multiple calculations and hence operators. For a serial multiplication shown in FIG. 2, standard base requires 2m (m+m=2m) AND gates 210, 230 and 2m−1 (m−1+m=2m−1) XOR gates 220 and 2m-bits DFFs. For parallel multiplication, standard base requires m*(m−1)+m*m=2m²−m AND gates and (m−1)(m−1)+m*m=2m²−2m+1 XOR gates.

Because a well-designed finite field multiplier is such an important factor for designing high-speed and low complexity decoders for high-speed communication systems, there is a present need for a finite fields multiplier architecture having a VLSI design with low complexity, low computational delay and high throughput rate.

Many prior art approaches and architectures have been proposed to perform finite fields multiplication and exponentiation. Different polynomial representations in standard basis, dual basis, normal basis, power representation and composite field over standard basis have been used to obtain some interesting realizations.

Dual basis arithmetic architecture, for example, has been presented in S. T. J. Fenn, M. Benaissa, D. Taylor: “GF(2^{m}) Multiplication and Division Over the Dual Basis,” IEEE Transactions on Computers, Vol. 45, No. 3, March 1998, pp. 319-327 (hereinafter called “Fenn et al.”), and also in R. Furness, M. Benaissa, S. T. J. Fenn: “Generalized Triangular Basis Multipliers for The Design of Reed-Solomon Codecs,” IEEE Proceedings—Computers and Digital Techniques, 1997, pp. 202-211 (hereinafter called “Furness et al.”).

Let B={β₀, β₁, . . . , βₘ₋₁} be a basis of GF(2^{m}). The dual basis {γ₀, γ₁, . . . , γₘ₋₁} of B is a basis satisfying,

$$Tr ( {βα}^{i} {γ}_{j} ) = \{ \begin{matrix}1 , where i = j \\ 0 , where i \neq j\end{matrix}$$

where β can be selected appropriately to simplify the conversion between standard and dual basis. There exists a dual basis for every base. Tr(γ) is a trace function defined as

$${\sum }_{k = 0}^{m - 1} {γ}^{{p}^{k}} .$$

In dual basis representation, aᵢ=Tr(βAαⁱ), 0≦i≦m−1.

Furness et al. discloses that for the primitive polynomial of the form p(x)=x^{m}+x^{k}+1 (trinomial), standard basis to dual basis conversion is a simple permutation of basis elements. For the primitive polynomial of the form p(x)=x+x^{k+1}+x^{k}+x^{k-1}+1 (1<k<m−1, pentanomial), standard basis to dual basis conversion can be performed using simple XOR gates and simple re-ordering of the basis coefficients.

FIG. 3 is a schematic diagram of a conventional bit-serial dual basis multiplier architecture, as disclosed by Fenn et al. The architecture is implemented by converting the element A from standard basis to dual basis before performing the multiplication operation, such that:
A=₀+a₁α+a₂α²+. . . +aₘ₋₁α^{m-1} in standard base
B=b₀λ₀+b₁λ₁+b₂λ₂+. . . +bₘ₋₁λₘ₋₁ in the corresponding dual base
p(x)=p₀+p₁x+p₂x²+. . . +pₘ₋₁x^{m-1}+x^{m} with p(α)=0

$$\begin{matrix}p ∘ B {=}^{Δ} {p}_{0} {b}_{0} + {p}_{1} {b}_{1} + {p}_{2} {b}_{2} + … + {p}_{m - 1} {b}_{m - 1} \\ [ \begin{matrix}{c}_{0} \\ {c}_{1} \\ ⋮ \\ {c}_{m - 1}\end{matrix} ] = [ \begin{matrix}{b}_{0} & {b}_{1} & ⋯ & {b}_{m - 2} & {b}_{m - 1} \\ {b}_{1} & {b}_{2} & ⋯ & {b}_{m - 1} & p ∘ B \\ {b}_{2} & {b}_{3} & ⋯ & p ∘ B & p ∘ ( α B ) \\ ⋮ & ⋮ & ⋰ & ⋮ & ⋮ \\ {b}_{m - 1} & p ∘ B & ⋯ & p ∘ ( {α}^{m - 3} B ) & p ∘ ( {α}^{m - 2} B )\end{matrix} ] \\ [ \begin{matrix}{a}_{0} \\ {a}_{1} \\ ⋮ \\ {a}_{m - 1}\end{matrix} ] {=}^{Δ} [ \begin{matrix}{b}_{0} & {b}_{1} & ⋯ & {b}_{m - 2} & {b}_{m - 1} \\ {b}_{1} & {b}_{2} & ⋯ & {b}_{m - 1} & {b}_{m} \\ {b}_{2} & {b}_{3} & ⋯ & {b}_{m} & {b}_{m + 1} \\ ⋮ & ⋮ & ⋰ & ⋮ & ⋮ \\ {b}_{m - 1} & {b}_{m} & ⋯ & {b}_{2 m - 3} & {b}_{2 m - 2}\end{matrix} ] [ \begin{matrix}{a}_{0} \\ {a}_{1} \\ ⋮ \\ {a}_{m - 1}\end{matrix} ] \\ {b}_{m + k} = {\sum }_{j = 0}^{m - 1} {p}_{j} {b}_{j + k}\end{matrix}$$

For serial multiplication shown in FIG. 3, dual base may require 2m (m+m=2m) AND gates 310, 330 and 2m−2(m−1+m−1=2m−2) XOR gates 320 and m-bits DFFs. For parallel multiplication, dual base requires m*(m−1)+m*m=2m²−m AND gates and (m−1)(m−1)+(m−1)m=2m²−3m+1 XOR gates. Compared with standard basis multiplier, dual basis multiplier may have less XOR gates. In one embodiment, there may be a longer path, such as two XOR chain shown in FIG. 3.

Using either the multiplier architecture in standard basis shown in FIG. 2 or the multiplier architecture in dual basis shown in FIG. 3, the inverter and exponentiator architectures may be implemented.

FIG. 4 is a schematic diagram of a conventional inverter/divider in standard or dual basis architecture. Notably, an inversion operation of the polynomial a 410 may be represented by: a⁻¹=a²^{^{m}}⁻²=a²·a⁴·a⁸·. . . a²^{^{m−1}}. Likewise, the division operation of polynomial b 420 by a, is b/a=b·a⁻¹=b·a²^{^{m−2}}=b·a²·a⁴·a⁸ . . . a²^{^{m−1}}. Thus, an inverter/divider 400 may process the inversion or division operation using a plurality of multipliers 430, registers 440 and multiplexors 480 to multiply the polynomials b and a⁻¹.

FIG. 5 is a schematic diagram of a conventional exponentiator in standard or dual basis architecture. In FIG. 5, a polynomial a 510 is raised to the power N 520. Here, N=nₘ₋₁·2^{m-1}+nₘ₋₂·2^{m-2}+. . . +n₁·2+n₀, such that a^{N}=aⁿ_{^{m−1}}^{·2}^{^{m−2}}⁺ⁿ_{^{m−2}}^{·m-2}^{+. . . +n}_{¹}^{·2+n}_{⁰}=(a)ⁿ_{⁰}·(a²)ⁿ_{¹}(a⁴)ⁿ_{²} . . . (a²^{^{m−1}})ⁿ_{^{m−1}}.

In contrast to the dual basis method, composite fields allow a reduction in the complexity of the operation, thereby improving the efficiency of hardware and software implementation. For example, an arithmetic architecture in composite field over standard basis has been presented in Christof Paar: “Efficient VLSI Architectures for Bit Parallel Computation in Galios Fields,” PhD Thesis, 1994 (hereinafter “Paar”).

If m=n·k, then it is possible to derive composite field by defining GF(2^{m}) over the field GF(2ⁿ). The field GF(2ⁿ) is called the ground field, while GF((2ⁿ)^{k}) can be used to denote composite field, as described by Paar.

The architecture for the GF((2ⁿ)²) multiplier, including polynomials A, B, and C is implemented, as follows:

For GF((2ⁿ)²), P(x)=x²+x+p₀, where p₀∈GF(2ⁿ)
A(x)=a₁x+a₀, B(x)=b₁x+b₀, where a₀, a₁, b₀, b₁∈GF(2ⁿ)
C(x)=A(x)B(x) mod P(x)=[a₁b₁x²+(a₀b₁+a₁b₀)x+a₀b₀] mod P(x)=(a₀b₁+a₁b₀+a₁b₀)x+(a₀b₀+p₀a₁b₁)=c₁x+c₀³. Multiplication terms a₀b₀, a₁b₁,a₀b₁, a₁b₀, and p₀a₁b₁ are under ground field GF(2ⁿ).

For serial multiplication, composite fields requires 2*(m/2)*4 AND gates and [2*(m/2)−1]*4+3=4m−1 XOR gates and 4m-bits DFFs. For parallel multiplication, composite fields requires [2*(m/2)²−(m/2)]*4=2*(m²)−2m AND gates and [2*(m/2)²−2*(m/2)+1]*4+(m/2)*3=2*(m²)+(5/2)*m+4 XOR gates. Therefore, in one embodiment, there are more gates for a serial multiplication than standard basis and dual basis. But throughput may be doubled because of the 2-bit serial operation. Moreover, for parallel multiplication, composite fields may require less AND gates than standard and dual basis and less XOR gates than standard basis. In one embodiment, the number of the above AND gates does not include the operation of p0*(a1b1) because it depends on the chosen p0. As an example, p0 may be chosen to minimize the number of gates for this operation. For the example of m=8, p0 may chosen as w¹⁴, the operation of which requires only 1 additional XOR gate.

Thus, to perform the arithmetic operations of inversion for GF((2ⁿ)²), solve for C(x) for the inversion equation: C(x)=1/B(x) mod P(x)=c₁x+c₀=(b₁/Δ)x+[(b₀+b₁)/Δ].

Similarly, to perform the arithmetic operations of division for GF((2ⁿ)²), solve for C(x) for the division equation: C(x)=[A(x)/B(x)] mod P(x)=c₁x+c₀=[(a₀b₁+a₁b₀)/Δ]x+{[a₀(b₀+b₁)+p₀a₁b₁]/Δ}, where A=b₀(b₀+b₁)+p₀b₀²C(x)=[A(x)/B(x)] mod P(x). Thus, rearranging the terms yields: A(x)=B(x)C(x) mod P(x)=(b₀c₁+b₁c₀+b₁c₁)x+(b₀c₀+p₀b₁c₁)=a₁x+a₀=[b₁c₀+(b₀+b₁)c₁]x+(b₀c₀+p₀b₁c₁).

By Cramer's rule, solve for c₀ and c₁:
a₀=b₀c₀+p₀b₁c₁,
a₁=b₁c₀+(b₀+b₁)c₁

Then c₀=[a₀(b₀+b₁)+p₀a₁b₁]/Δ, c₁=(a₀b₁+a₁b₀)/Δ.

A drawback of the composite method is that it is a semi-serial and compromised solution.

Thus, both the dual basis method and composite field methods have certain disadvantages that adversely effect VLSI design. It is desired to create a VLSI architectural design for multiplication, inversion, division and exponentiation with low complexity, low computation delay and high throughput rate is of great practical concern in hardware implementation.

### BRIEF SUMMARY OF THE INVENTION

A method for performing arithmetic operations according to the present invention includes receiving a first data stream defined over a composite field and receiving a second data stream defined over the composite field. An arithmetic operation is performed on the first and second data stream using dual basis arithmetic.

### BRIEF DESCRIPTION OF THE DRAWINGS

FIG. 1 is a schematic diagram of a conventional finite field GF(2^{m}).

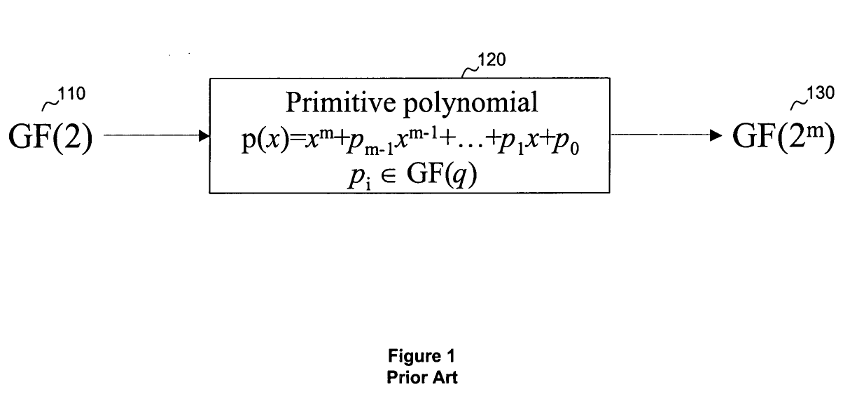

FIG. 2 is a schematic diagram of a conventional bit-serial standard basis multiplier architecture.

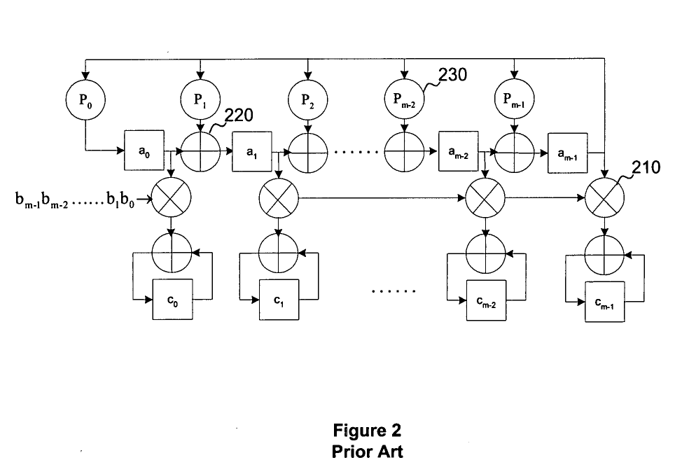

FIG. 3 is a schematic diagram of a conventional bit-serial dual basis multiplier architecture.

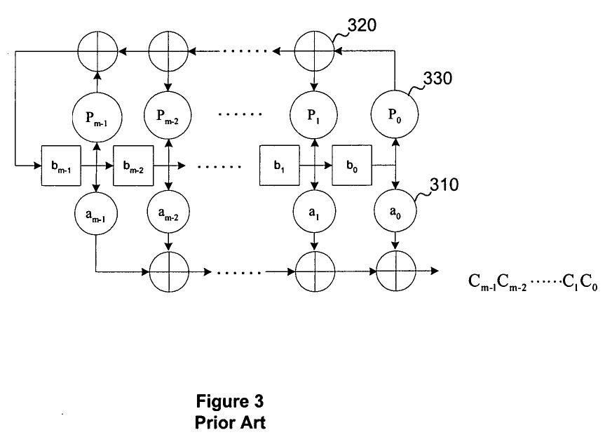

FIG. 4 is a schematic diagram of a conventional inverter/divider in standard or dual basis architecture.

FIG. 5 is a schematic diagram of a conventional exponentiator in standard or dual basis architecture.

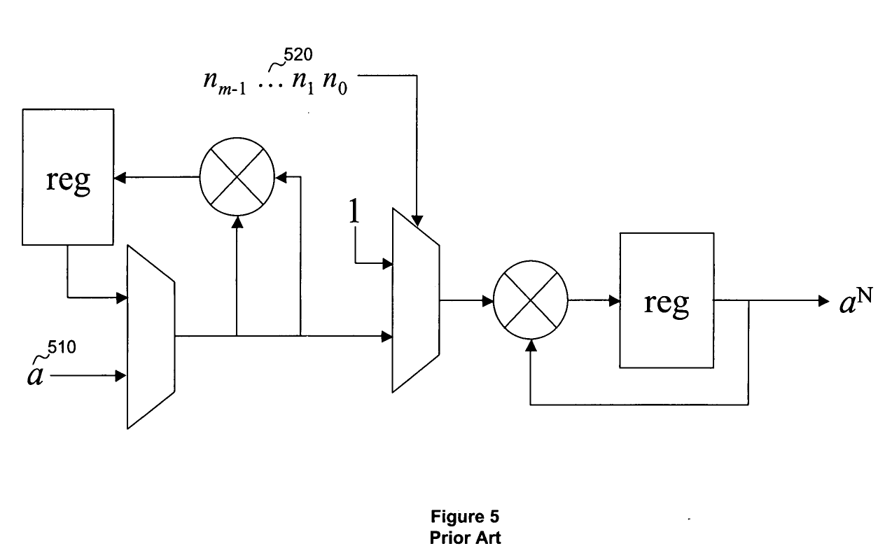

FIG. 6 is a schematic diagram of a multiplier architecture according to an exemplary embodiment of the present invention.

FIG. 7 is a schematic diagram of an aspect of an inverter architecture according to an exemplary embodiment of the present invention.

FIG. 8 is a schematic diagram of a divider architecture according to an exemplary embodiment of the present invention.

FIG. 9 is a schematic diagram of an exponentiator architecture according to an exemplary embodiment of the present invention.

### DETAILED DESCRIPTION OF THE INVENTION

The present invention combines elements of a finite fields arithmetic in dual basis and composite field to design a high-speed and area efficient multiplier, divider and exponentiator. These elements are useful in but not limited to, for example, Reed-Solomon encoder/decoder, syndromes calculation, Berlekamp algorithm, Chien Search algorithm, and Formey algorithm.

All the operations of the present invention are performed under composite field over dual basis. In other words, for GF((2ⁿ)^{k}) composite field, arithmetic in ground field GF(2ⁿ) is performed over dual basis. Because the standard basis to dual basis conversion is simply coefficients (in GF(2)) permutation, the basis conversion overhead is minimal.

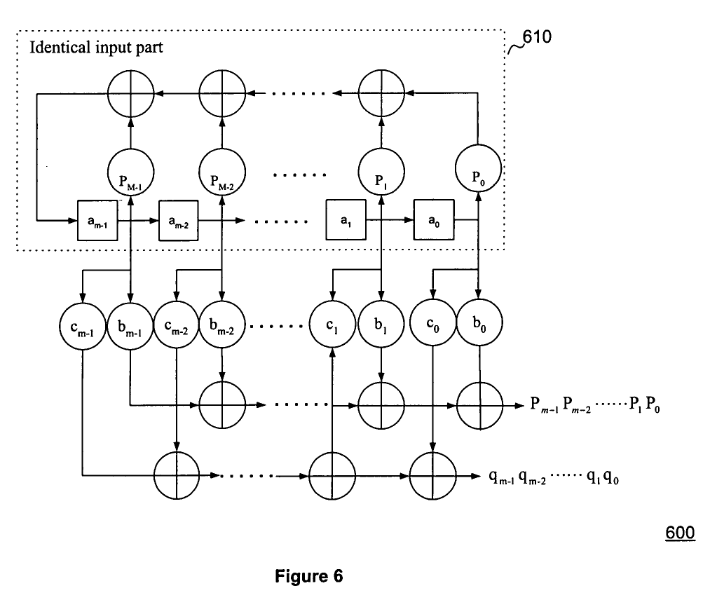

FIG. 6 is a schematic diagram of a multiplier architecture according to an exemplary embodiment of the present invention. Multiplier 600 is based on a GF((2ⁿ)²) composite field, in which the arithmetic in the ground field GF(2ⁿ) is performed over dual basis. Thus, for GF((2ⁿ)²), P(x)=x²+x+p₀, where p₀∈GF(2ⁿ). A(x)=a₁x+a₀, and B(x)=b₁x+b₀, where a₀, a₁, b₀, b₁∈GF(2ⁿ). Thus, C(x)=A(x)B(x) mod P(x)=[a₁b₁x²+(a₀b₁+a₁b₀)x+a₁b₀] mod P(x)=(a₀b₁+a₁b₀+a₁b₁)x+(a₀b₀+p₀a₁b₁)=c₁x+c₀.

That is, for ground field multiplication, the terms are a₀b₁, a₁b₀, a₁b₁, a₀b₀ and p₀a₁b₁. The factor a₁b₁ is common to a₁b₁, and p₀a₁b₁. Similarly, the pairs (a₀b₀, a₀b₁) and (a₁b₀, a₁b₁) each have a common element within the pair. By exploiting these identical terms, the multiplier architecture of the present invention may reduce hardware requirements. More particularly, multipliers in each pair may share portions of the input circuit having identical terms. In FIG. 6, multiplier 600 shares part 610 of the input circuit, thereby reducing circuit complexity. In one embodiment, a serial multiplication may requires 2*(m/2)+4*(m/2)=3m AND gates and 2*[(m/2)−1]+4*[(m/2)−1]+3=3m−3 XOR gates and m-bits DFFs. And a parallel multiplication may require 2*{(m/2)[(m/2)−1]}+4*[(m/2)²]=(3/2)*(m²)−m AND gates and 2*{[(m/2)−1]²}+4*{[(m/2)−1](m/2)}+3*(m/2)=(3/2)*(m²)−(5/2)m+2 XOR gates. Accordingly, there may be less gates for a serial multiplication than composite fields with the same throughput advantage of the 2-bit serial operation. Moreover, the critical path of XOR chain may be shortened, such as to become half the length of the path for a dual basis multiplier. For a parallel multiplication, the gate reduction order is from 2*(m²) to (3/2)*(m²). In some embodiments, throughput and area may be compromised for a serial operation. Gate count may be reduced for a parallel operation.

An inverter based on a GF((2ⁿ)²) composite field, in which the arithmetic in the ground field GF(2ⁿ) is performed over dual basis is described next. For GF((2ⁿ)²), P(x)=x²+x+p₀, where p₀∈GF(2ⁿ). Further, A(x)=a₁x+a₀, B(x)=b₁x+b₀, where a₀, a₁, b₀, b₁∈GF(2ⁿ).

C(x)=A(x)/B(x) mod P(x)=[a₁b₁x²+(a₀b₁+a₁b₀)x+a₁b₀] mod P(x)=(a₀b₁+a₁b₀+a₁b₁)x+(a₀b₀+p₀a₁b₁)=c₁x+c₀=(Δ₁/Δ)x+(Δ₀/Δ), where a₀, a₁, b₀, b₁, c₀, c₁, Δ, Δ₀, Δ₁∈GF(2ⁿ). Further, Δ₀=a₀(b₀+b₁)+p₀a₁b₁, Δ₁=a₀b₁+a₁b₀, and Δ=b₀(b₀+b₁)+p₀b₁². Thus, it can be found that Δ₁x+Δ₀=[b₁x+(b₀+b₁)](a₁x+a₀) and Δx+Δ=[b₁x+(b₀+b₁)](b₁x+b₀).

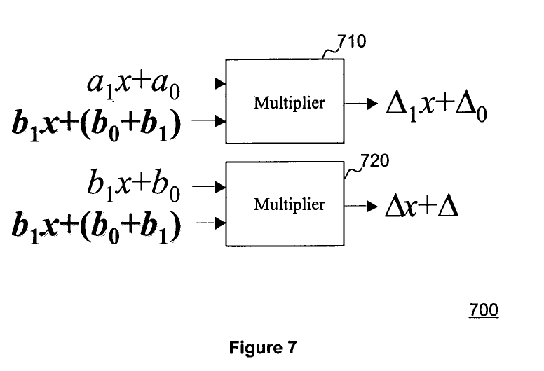

FIG. 7 is a schematic diagram of an aspect of an inverter architecture according to an exemplary embodiment of the present invention. Multipliers 710 and 720 have the same architecture as multiplier 600. Multipliers 710 produces output Δ₁x+Δ₀; whereas, multiplier 720 produces the output Δx+Δ. As shown, these two multipliers have an identical input term b₁x+(b₀+b₁). Thus, the inverter according to the present invention may increase efficiency further by sharing hardware to implement the identical part of ground field multiplication.

Next, the architecture for the division part (Δ₀/Δ) and (Δ₁/Δ) is explored. Here, b/a=b·a⁻¹=b·a^{2m-2}=b·a²·a⁴·a⁸ . . . a^{2m-1}. It can be found that the square-portion and multiplication-portion of the above equation have one identical input. Since the terms (Δ₀/Δ) and (Δ₁/Δ) can be expressed as

$$\{ \begin{matrix}{Δ}_{0} \text{/} Δ = {Δ}_{0} \cdot {Δ}^{- 1} = {Δ}_{0} \cdot {Δ}^{{2}^{n} - 2} = {Δ}_{0} \cdot {Δ}^{2} \cdot {Δ}^{4} \cdot {Δ}^{8} … {Δ}^{{2}^{n -} 1} \\ {Δ}_{1} \text{/} Δ = {Δ}_{1} \cdot {Δ}^{- 1} = {Δ}_{1} \cdot {Δ}^{{2}^{n} - 2} = {Δ}_{1} \cdot {Δ}^{2} \cdot {Δ}^{4} \cdot {Δ}^{8} … {Δ}^{{2}^{n -} 1}\end{matrix}$$

The square part for Δ⁻¹ can be shared.

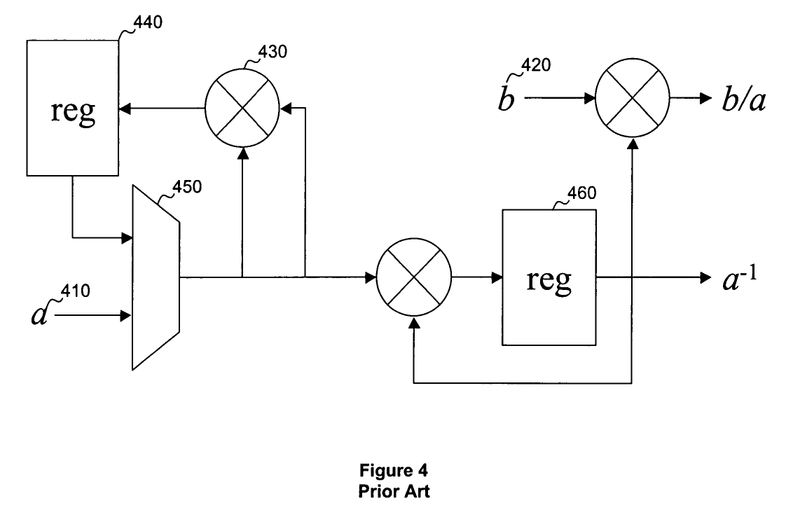

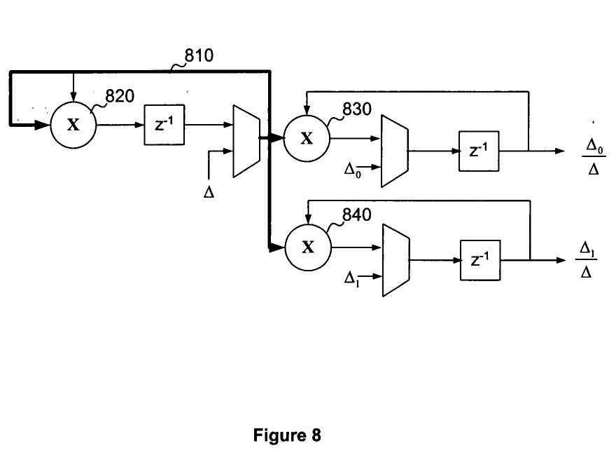

FIG. 8 is a schematic diagram of a divider architecture according to an exemplary embodiment of the present invention. The ground field multipliers have one identical input 810 (shown as the bold line). Thus, multipliers 820, 830 and 840 may share the circuit of the identical input part 810, thereby achieving further hardware area reduction. Comparing with FIG. 4, this architecture may inherently remove the operation of b·a⁻¹ by one additional multiplexor to preset the register 460 to initial value b. Therefore, this may also reduce the total area needed for the circuit.

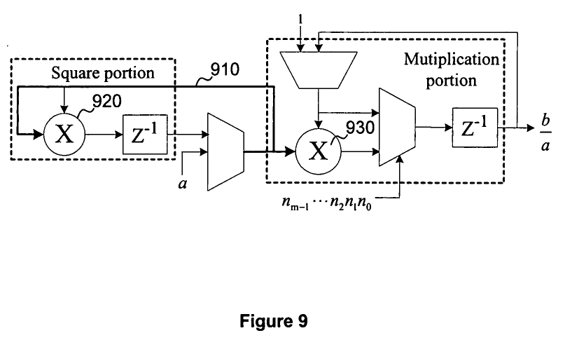

FIG. 9 is a schematic diagram of an exponentiator architecture according to an exemplary embodiment of the present invention.
For a^{N},N−nₘ₋₁·2^{m-1}+nₘ₋₂·2^{m-1}·2^{m-2}+. . . +n₁·2+n₀.
a^{N}=aⁿ^{^{m−1}}^{·2}+nₘ₋₁2^{m-2}+. . . +n₁·2+n₀=(a)n₀·(a²)ⁿ₁(a⁴)ⁿ₂ . . . (a^{2·m-1})ⁿₘ₋₁

Applying the same hardware sharing technique described above, the exponentiator according to the present invention shares an identical input 910 (bold line of square part and multiply part). Allowing multipliers 920 and 930 to share the identical input 910 results in a reduces the complexity of the architecture.

An architecture according to the present invention performs arithmetic operations on a composite field over dual basis. The ground field arithmetic is performed under dual basis. Therefore, the proposed architectures have the advantages of both composite field and dual basis processing. Namely, the hybrid architecture of the present invention has the area efficiency associated with composite field and the timing efficiency associated with dual basis. Moreover, if the ground field GF(2ⁿ) arithmetic is implemented by bit-serial operation, the overall throughput of the composite field GF((2ⁿ)^{k}) arithmetic will be twice than the one implemented in the finite field GF(2^{m})m=nk). Hence, the proposed finite fields arithmetic architectures have all the advantage of area, timing and throughput simultaneously.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A method for performing arithmetic operations, comprising:
receiving a first data stream defined over a composite field;
receiving a second data stream defined over the composite field; and
performing an arithmetic operation on the first and second data stream using dual basis arithmetic.

2. The method of claim 1, further comprising:
sharing hardware to implement common input coefficients.

3. The method of claim 1, wherein the arithmetic operation is ground field multiplication.

4. The method of claim 1, wherein the arithmetic operation is ground field division.

5. The method of claim 1, wherein the arithmetic operation is ground field exponentiation.

6. The method of claim 1, wherein the first data stream is an extension field A(x) belonging to GF((2ⁿ)^{k}) and generated from a primitive polynomial p(x) over GF(2ⁿ);
the second data stream is an extension field B(x) belonging to GF((2ⁿ)^{k}) and generated from a primitive polynomial p(x) over GF(2ⁿ); and
the arithmetic operation is performed modulo p(x) in dual basis.

7. A system for performing arithmetic operations, comprising:
a first receiver for receiving a first data stream defined over a composite field;
a second receiver for receiving a second data stream defined over the composite field; and
a modular arithmetic circuit for performing an arithmetic operation on the first and second data stream using dual basis arithmetic.

8. The system of claim 7, further comprising:
shared hardware for implementing common input coefficients.

9. The system of claim 7, wherein the arithmetic operation is ground field multiplication.

10. The system of claim 7, wherein the arithmetic operation is ground field division.

11. The system of claim 7, wherein the arithmetic operation is ground field exponentiation.

12. The system of claim 7, wherein
the first data stream is an extension field A(x) belonging to GF((2ⁿ)^{k}) and generated from a primitive polynomial p(x) over GF(2ⁿ);
the second data stream is an extension field B(x) belonging to GF((2ⁿ)^{k}) and generated from a primitive polynomial p(x) over GF(2ⁿ); and
the arithmetic operation is performed modulo p(x) in dual basis.
